(19) United States
(12) Patent Application Publication
(10) Pub. No.: US 2001/0027710 A1
(43) Pub. Date: Oct. 11, 2001

(54) Circular shaped punch unit, in particular for making a hole for the binding comb of a ring binding

(76) Inventor: Axel Lewandowski, Gottmadingen (DE)

Correspondence Address: Lewandowski Axel, Industriepark 206, Gottmadingen, 78244, DE

(21) Appl. No.: 09/768,692

(22) Filed: Jan. 16, 2001

(30) Foreign Application Priority Data
Jan. 14, 2000 (DE) 10001 238.8

(51) Int. Cl. B26F 1/00

(52) U.S. Cl. 83/690

(57) ABSTRACT

A punch unit, in particular for making a punch for the binding comb of a ring binding is set-up of a circular shaped blade 1 and a counter die 19. The circular blade 1 is rotatably beard concerning an axis of rotation 27. At the circumference of the blade 1 cutting elements 2 are arranged. This cutting elements 2 raise over a fictive rolling circle 21. The surface of the counter die 19 is arranged perpendicular at the distance of the rolling circle radius r_{w}, to the axis of rotation 27 of the circular blade 1 and show one or several opening in which in each case intervenes at least one cutting element 2 of the circular blade 1.

### BACKGROUND OF THE INVENTION

The invention concerns a punch unit, in particular for making a punch for the binding comb of a ring binding. Punch units for punching a hole for a binding comb are confessed by modifications from the state of the art at a great number.

An essential problem of these known procedures is that punching holes into a pile of paper consisting of a greater number of single pages is only very heavily possible.

From that state of the art, different measures are now confessed in order to ease the described problems.

So is for example from that U.S. Pat. No. 3,227,023 a combined punch- binding machine for flexible ring plastic binding elements known.

At the described punch unit, the paper which has to be provided with the holes is arranged on a horizontal supporting surface against a detent in longitude direction and a detent in cross direction below a linear punching tool with teeth shaped stamping elements. The linear punching tool with the teeth shaped stamping elements is then sloped by a lever. With it the stamping elements pierce the paper. The individual stamping elements which are designed for example as a punching knife support themselves in each case against the corresponding stop. Therefore, the process of the punch is a pure stamping process.

Individual stops of the punch unit can be switched on and off. As a result, the corresponding the punching knives insert no more stamping force onto the paper and a punch of the paper in the corresponding places does not occur. As a result, the necessary strength is reduced for the production of the holes. However, a complete punch of an extensive document must be carried out in several operation steps.

Moreover, the loose stops for the individual punching knives are not carried out with respect to the supporting surface level with the pile of paper in a tier but its distances of the supporting surface increase from one side of the linear punching tool to the other side. With it is achieved that the punching knives do pierce the paper not simultaneously but pierce it in sequence. The strength to be spent is reduced too in this manner.

### BRIEF SUMMERY OF THE INVENTION

Starting from this state of the art, the invention is based on the task to further simplify the punch process and to form the punch process more efficiently for the user.

This task is solved invention appropriately by a punch unit, in particular for making holes for a binding comb of a ring binding, with the following features:

The punch unit shows a preferably circular blade which is pivot concerning an axis, with one or several cutting elements arranged at the circumference of the circular blade which rise over a fictive rolling circle radius with rolling circle radius r_{w}. Furthermore, the punch unit shows a counter die, which show a surface perpendicular to the circular blade again at the distance of the rolling circle radius r_{w}. Further, this counter die has one or several opening, into those one or several of the cutting elements which are arranged on the circumference of the circular blade intervene simultaneously in each case.

A paper which has to be perforated is perpendicular to the blade at the distance of the rolling circle radius r_{w} of the axis of rotation of the blade on that listed above surface of the counter die arranged. The paper must move relatively to the axis of rotation of the circular blade circumferential speed of the fictive rolling circle while turning the circular blade. By the rotary motion of the circular blade and the simultaneous linear relative movement of the paper in sense of rotation the cutting elements in sequence pass through into the paper and make the desired holes for the binding comb of a ring binding.

On account of the rigid distance between the axis of rotation of the circular blade and the counter die and/or the paper, the punch process does not occur as while the known version in an essentially linear movement of the punching tool but by a rotative movement of the blade the cutting elements cut at first on one side into the paper and the cutout of the counter die.

The torque required by the rotary motion can for example be raised with the aid of a cranked control handle or by a motor drive, where appropriate interlinked with a corresponding gear pair.

In this case, the cutting elements are as designed, that they raise with their cutting edge over the rolling circle radius r_{W} of the rolling circle.

That opening of the counter die show cutting edges that are assigned in each case to the cutting edges of the cutting elements. The cutting edges of the cutting elements and the cutting edges of the opening are arranged to each other as that they are similar to the mode of operation of a scissors through to the gliding along the sharp edges the paper is cut up by a pulling cut.

The process of the punch indeed still resembles a stamping process, however, the amount of force (and/or the required torque) is reduced clearly compared to a pure stamping process.

The punch unit is carried out in the way, that the used cutout angles between the normal of the surface of the counter die and the walls of the opening is chosen so large that a rubbing of front edges of the cutting elements at the surface of the counter die is avoided. Alternative or additional a cutout angle between a straight line running radially through the axis of rotation of the circular blade and the side edges of the cutting elements is chosen so large that a rubbing of the side edges of the cutting elements on the walls of the opening of the counter die is avoided. Both measures leading to a further minimization of the required amount of force for the production of a punch.

An especially useful version of the invention shows that the cutting elements are made form a material unit with the circular blade. This measure in particular has manufacturing advantages. On the one hand, assembly costs can be avoided for fixing the cutting elements at the circular blade. On the other hand, the production of the blade is possible with the cutting elements in a working cycle.

A further useful version of the invention shows that the cutting elements at the distance of the rolling circle radius r_{W} from the axis of rotation of the circular blade have the cross section, which correspond to the cross section of the punch to be made for the binding comb of the ring binding. This measure causes an unchangeably high quality of the punch, which at least is comparably with the punch made by dice.

For the production of a punch with preferably rectangular cross section, the cutting elements show a swallowtail shaped basic body. This basic body preferably shows a constant axial thickness which basically corresponds to a hole width of the hole to be made.

The width of the swallowtail shaped basic body in circumference direction at the distance of the outside radius r_{A} from the axis of rotation of the blade is given through the punch length of the hole to be made. The basic body at its radially inner foot is limited by the side edges and at its radially outer surface through the cutting edges. Such a shape of the cutting elements is very simply producible, in particular then, if the cutting elements form a material unit with the blade.

The counter die surface is advantageous build up as a plane tier, or it is arranged on the circumference of a disc, so that the counter die surface basically builds up a cylinder barrel.

In an especially useful version of the invention the surface of the counter die moves during the turning of the circular blade relative to its axis of rotation perpendicular to the blade at the distance the rolling circle radius r_{W} of the axis of rotation of the blade with a circumferential speed of the fictive rolling circle. It is unimportant in this case whether the counter die surface is fixed and the circular blade only moves or whether the circular blade and the counter die move. The relative movement is alone decisive. Therefore, in this version of invention in the case of a flat counter die no relative movement of the paper occurs to the counter die itself.

Further on the invention shows, that the number of cutting elements which are simultaneously in contact with the opening of the counter die is optional changeably. Such a variability on the one hand, is possible by a corresponding order of the cutting elements, on the other hand, by a corresponding choice of the rolling circle radius for r_{W} of the rolling circle and the radius of the cylinder on that the counter die is positioned. Consequently is it possible to choose the amount of force and the necessary torque for the punch process with the number of cutting elements which are simultaneously in contact with the opening of the counter die.

The cutting edges of the opening of the counter die preferably have the shape, which correspond to the cross section of the holes to be made for the binding comb of the ring binding.

An especially useful version of the invention consists in the fact that the surface of the counter die and therefore the counter die itself stands still relative to the axis of rotation of the circular blade while turning the circular blade. Such a set-up is especially useful, if the counter die surface is build up as a tier. In this case only one opening in the counter die is necessary into those the cutting elements of the circular blade in sequence may intervene.

In the case of the punch process the paper which is arranged on the counter die moves here over the matrix surface with the circumferential speed of the fictive rolling circle of the blade so that the cutting edges of the cutting elements cut the hole into the paper.

In an especially useful version of invention the cutting edges of the cutting elements are carried out in such a way, that they do not at least in the beginning of the punch process cut into paper simultaneously. This is the case if the cutting edges raise differently high over the rolling circle radius and show increasing edges. The necessary cutting force and therefore the necessary torque can be further decreased by this measure to the blade.

Further useful is if the punch unit is arranged in combination with a single-page thread and/or a paper screening plant and/or a binder. Such a configuration is reasonable, if the binding procedure should be automatized.

### BRIEF DESCRIPTION OF THE SEVERAL VIEWS OF THE DRAWING

Useful versions of the invention are represented in the drawing and are described more in the following. The drawings show:

FIG. 1 a top view onto a circular blade with material homogeneous cutting elements,

FIG. 2 a view in the axial half cut of the circular blade according to FIG. 1

FIG. 3 a top view onto a flat counter die with openings,

FIG. 4 a sectional drawing of the counter die according to FIG. 3,

FIG. 5 a top view of a further circular blade with material homogeneous cutting elements,

FIG. 6 a view in the axial half cut of the circular blade according to FIG. 5

FIG. 7 a top view onto a flat counter die fit to the circular blade according to FIGS. 5 and 6,

FIG. 8 a sectional drawing of the counter die according to FIG. 7,

FIG. 9 a top view onto a disc with a counter die arranged on its circumference,

FIG. 10 a view in the axial half cut of the disc according to FIG. 9.

### DETAILED DESCRIPTION OF THE INVENTION

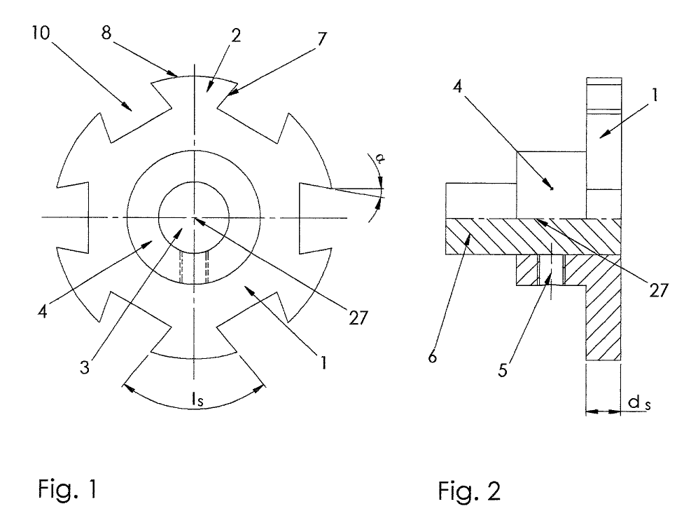

FIGS. 1 and 2 show a first invention appropriate version of a circular blade 1 with material homogeneous cutting elements 2. Such a circular blade 1 consists of a circular, normally metallic basic body with a blade thickness d_{S}. This blade thickness d_{S} essentially corresponds to the hole width b_{L} of a hole to be made. In practice, the hole widths b_{L} are usual about two to four millimeters.

The circular blade 1 shows at its external circumference swallowtail shaped incisions 10. On account of these incisions 10 at the external circumference of the circular blade 1 also swallowtail shaped cutting elements 2 are created. The thickness of the swallowtail shaped basic body of the cutting elements 2 consequently, corresponds the blade thickness d_{S}. This swallowtail shaped basic body is limited on the side through side edges 7 and at its outer front surface through cutting edges 8. Therefore, the cutting edges 8 form a segment of a circle in circumference direction with the cut edge length l_{S}. A straight line running radially through the center of circular blade 1 and the side edges 7 of the cutting elements 2 include a cutout angle, that is designated with α. The cut edge length l_{S} of the cutting edge 8, created by the preferably circle segment shaped cutting elements 2 conducts in practice preferably about 2 to 10 mm.

In order to be able to put the circular blade 1 into rotary motion, the circular blade 1 must be interlinked via axis of rotation to a cranked control handle or an engine. In the case of this version, the circular blade continues itself material homogeneously for this purpose as a cylindrical coupling 4. The outer diameter of this round coupling 4 is less than the outer diameter of circular blade 1 on which the cutting elements 2 are placed. In place of a such a material homogeneous coupling 4, it is also possible to attach such a coupling to the circular blade 1 with the aid of fixing elements (for example with the aid of screws or similar elements).

In the example, the coupling 4 and circular blade 1 is provided with a central boring 3. The center of this central boring 3 forms the axis of rotation 27. The central boring 3 is used for the insert of an axis 6. In the example the central boring 3 shows a circular cross section. A further favoured carrying out form is a polygonal cross section.

In the example, the cylindrical coupling 4 shows a radial boring 5 with an inside thread, into which one a screw is inserted for the fixation of the axis 6 in the central boring 3.

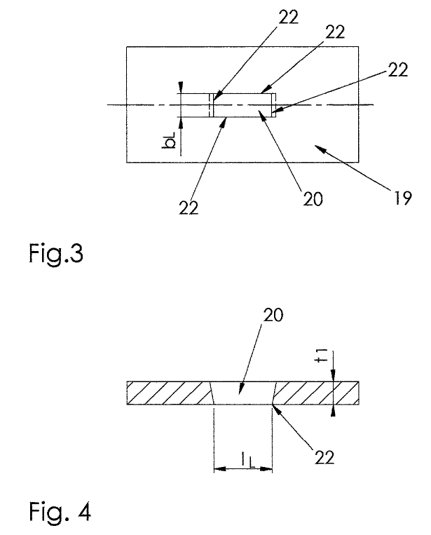

As a counterpart to the circular blade 1 serves counter dies according to FIGS. 3 and 4 or 9 and 10.

FIGS. 3 and 4 show a flat counter die 19 which shows a two-dimensional flat surface. One or several opening 20 pierce the depth t₁ of the flat counter die 19. The cross section of the opening 20 of the counter die 19 on its surface essentially corresponds to the cross section of the hole to be made for the binding comb of the ring binding. In this case, the hole to be made shows a rectangular cross section for the binding comb with the hole width of b_{L} and of the punch length 1_{L}.

Between the perpendicular on the surface of the flat counter die 19 and the inside walls of the opening 20 of the flat counter die 19, a cutout angle β is formed.

The two cutout angles α and β of the circular blade 1 and/or the counter die 19 are preferably chosen so large that a friction of the side edges 7 of the cutting elements 2 on the walls of the opening 20 of the flat counter die 19 is avoided.

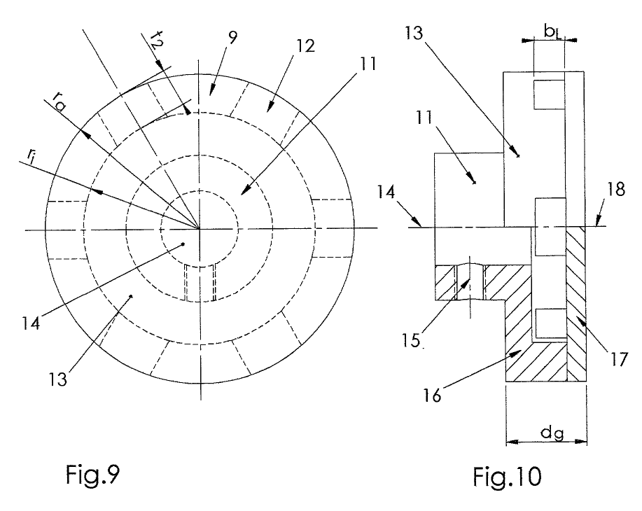

FIGS. 9 and 10 show a further version of the invention in which the counter die 9 is arranged on the circumference of a disc 13.

The disc 13 with the counter die 9 is carried out in this version with two parts. It consists of a basic body 16 with material homogeneous coupling 11 and a second disc 17.

The basic body 16 essentially consists of a circular disc of the basic body thickness d_{G}. This basic body 16 shows an axial boring with a depth which corresponds to the hole width b_{L}. The boring radius corresponds to the inner radius rᵢ in accordance with FIG. 9. The outside radius of the basic body is in the drawing with rₐ designated.

The cylinder caused by this boring of the thickness t₂=rₐ−rᵢ which represents the depth t₂ of counter die 9. This cylinder shows opening 12 preferably inserted by milling. This opening 12 correspond to the opening 20 of the flat counter die 19 in accordance with FIG. 3 and FIG. 4. The cross section of this opening at the outer surface of the basic body 16, which is shaped as a cylinder, corresponds basically analog to FIG. 3 and FIG. 4 the cross section of the punch to be made for the binding comb of the ring binding, therefore in the example a rectangular cross section with the punch length l_{L} and the hole width b_{L}.

The coupling which is in material unit to the basic body 16 is carried out analogous to that of the circular blade 1 according to FIGS. 1 and 2. The coupling has a central boring 14 which is used for the insert of an axis and a radial boring 15 (with an inside thread) for the insert of a fixing element (in the example of a screw).

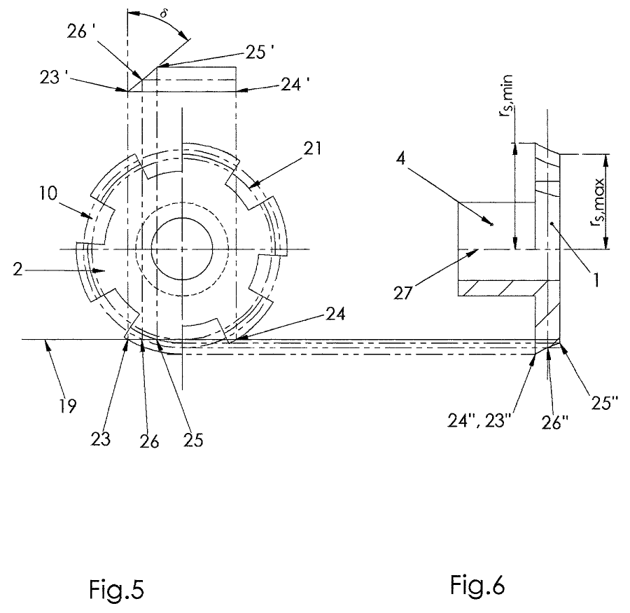

For the further reduction of the cutting forces in the case of the punch process, a version of the punch unit is, in particular the circular blade 1 in accordance with FIG. 5 and FIG. 6 possible.

Basically the circular blade 1 consists like in the first version of a normally metallic circular basic body with a blade thickness d_{S}. This blade thickness d_{S} basically corresponds to the hole width b_{L} of a hole to be made.

The circular blade 1 shows swallowtail shaped incisions 10 at its outer circumference. On account of these incisions 10, are the cutting elements 2 at the outer surface of the circular blade 1 also swallowtail shaped. Consequently, the thickness of the basic body of the swallowtail shaped cutting elements 2 corresponds to the blade thickness d_{S}.

In contrast to the previous versions the radius of circular blade 1 changes with the blade thickness d_{S}. In accordance with FIG. 6 the radius r_{S} of the circular blade increases from a minimum value r_{S.min} on the front of circular blade 1 to the reverse side of the circular blade 1 to the maximum radius of the r_{S.max}. In the example the increase of the radius r_{S}, is not linear but progressive so that the projection of a cutting element 2 onto a tier normally to the tier of the circular blade 1 shows a trapezoidal form.

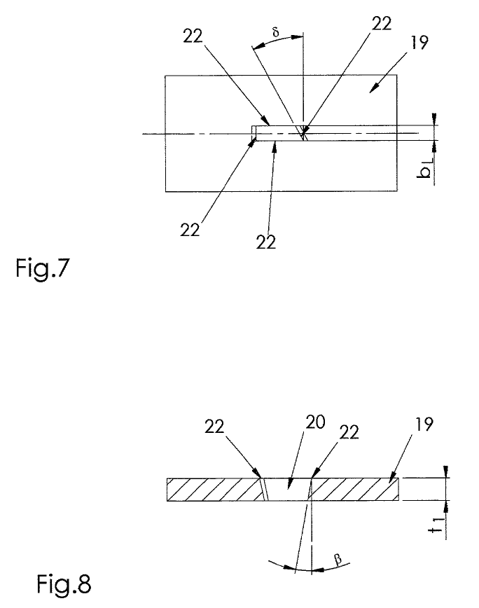

The trapezoidal form of the flat counter die 19 represented in FIG. 7 and FIG. 8 can be constructed from the circular blade 1 as represented in FIGS. 5 and 6.

In practice however, are the geometrical forms of the projection tier defaulted and the corresponding cutting edges 8 of cutting elements 2 constructed.

The length of the opening 20 of the counter die is determined by the depth of insertion of the circular blade 1 into the flat counter die 19. The point 23 of the entry of the maximum radius r_{S.max} of the circular blade 1, point 25 of the entry of the minimum radius r_{S.min} of the circular blade 1 and point 24 of the withdrawal of the maximum radius r_{S.max} of the circular blade 1 of the flat counter die 19 are resulted. As a further point a further point of entry 26 of the circular blade is shown in FIG. 5.

The points 23 and 24 define the points 23′ and 24′ in the tier of the flat counter die 19 and therefore the length of the cross section of the opening 20 of the counter die 19.

In the example, the cross section of the opening 20 of the counter die shows a trapezoidal shaped form, with three sides perpendicular to each other and one side, that includes an angle δ with the shortest side of the trapeze.

From this projection angle δ the form of the rounding of the generated surface of the circular blade can be developed. Points 23, 24, 25 and 26 become projected onto the cutting tier. They make the points 23′, 24′, 25′ and 26′ on the cutting tier. These points 23′, 24′, 25′ and 26′ are also on the surface of the cutting elements 2 and describe by the rotative movement of the circular blade 1 a circular orbit. The intersection points of the circular orbit with the cutting edge 8 of the cutting elements 2 make the points 23″, 24″, 25″ and 26″ in accordance with FIG. 6. In the example is it possible to reconstruct in turn with the points 23″, 24″, 25″ the curve of the cutting edge 8 of the cutting elements 2.

Such versions of a punch unit described in FIGS. 1 to 10 are suitable for integration into a traditional binder. Furthermore, a combination with a single-page thread and/or a paper screening plant leads to the automatization of the punch and binding procedure.

### Position Mark List

circular blade

cutting element

central boring

coupling

radial boring

axis

side edge

cutting edge

counter die

incision

coupling

opening

disc with counter die on the circumference

central boring

radial boring

basic body

disc

central boring

flat counter die

opening

rolling circle

cutting edge

entry point of r_{S.max}

23′ projection of entry point 23 onto the cutting tier

23″ point on the cutting edge of cutting element 2 in accordance with entry point 23 and the projection

23′ of entry point 23

24 withdrawal point of r_{S.max}

24′ projection of entry point 24 onto the cutting tier

24″ point on the cutting edge of the cutting element 2 in accordance with the entry point 24

25 entry point of r_{S.min}

25′ projection of entry point 25 onto the cutting tier

25″ point on the cutting edge of the cutting element 2 in accordance with the entry point 25

26 further entry point

26′ Projection of entry point 26

26″ Point on the cutting edge of the cutting element 2 in accordance with the entry point 26

27 Axis of rotation

α cutout angle

β cutout angle

δ projection angle

l_{S} cut edge length

d_{S} blade thickness

d_{G} basic body thickness

t₁, t₂ depth

rₐ outside radius

rᵢ inside radius

l^{L} hole length

b_{L} hole width

r_{S.max} maximum radius of the blade

r_{S.min} minimum radius of the blade

r_{W} rolling circle radius

r_{S}. Radius of blade 1

What I claim as my invention is:

1. A punch unit, in particular for making holes for a binding comb of a ring binding
with a preferably circular blade 1 rotatably beard concerning an axis of rotation 27,
with one or several on the circumference of the circular blade 1 arranged cutting elements 2, which raise over an fictive rolling circle 21 with the rolling circle radius r_{W},
with a counter die 9, 19, where one surface of the counter die 9, 19 is arranged perpendicular to the circular blade 1 at the distance of the rolling circle radius r_{W} of the axis of rotation 27 of the blade 1 and show one or several opening 12, 20, in which in each case intervenes at least one cutting element 2 of the circular blade 1, 13.

2. Punch unit according to one of the previous claims, characterized through that the cutting elements 2 show at least one side edge 7 raising over the rolling circle radius r_{W} of rolling circle 21 and
show at least one cutting edge 8 raising over the rolling circle radius r_{W} of an fictive rolling circle 21.

3. Punch unit according to claim 2, characterized through that the opening 12, 20 of the counter die 9, 19 in each case show cutting edges 22 which are assigned to the cutting edge(s) 8 of the cutting elements 2.

4. Punch unit according to claim 3, characterized through that a cutout angle β between a perpendicular on the upper surface of the counter die 9, 19 and the inner wall of the opening 12, 20 of the counter die 9, 19 is chosen so largely that a friction of the of the side edges 7 of the cutting elements 2 on the walls of the opening 12, 20 of the counter die 9, 19 is avoided.

5. Punch unit according to claim 3 or 4, characterized through that a cutout angle α between a straight line running radially through the axis of rotation 27 of the circular blade 1 and the side edges 7 of the cutting elements 2 is chosen so largely that a friction of the side edges 7 of the cutting elements 2 on the walls of the opening 12, 20 of the counter die 9, 19 is avoided.

6. Punch unit according to one of the previous claims, characterized by, that the cutting elements 2 form a material unit with blade 1.

7. Punch unit according to one of the previous claims, characterized by, that the cutting elements 2 at the distance of the outside radius rₐ from the axis of rotation 27 of the blade 1, show cross sections which basically correspond to the cross sections of the holes to be made for the binding comb of the ring binding.

8. Punch unit after one of the previous claims, characterized by, that the hole to be made forms a preferably rectangular cross section.

9. Punch unit according to claim 8, characterized through that the cutting elements 2 show a swallow shaped basic body with a thickness d_{S}, that basically corresponds to a width of the hole b_{L} to be made,
and that the cutting elements 2 at the distance of the outside radius rₐ from the axis of rotation 27 of the blade 1, show a circular arc length that basically corresponds to a hole length l_{L} of the hole to be made.

10. Punch unit according to one of the previous claims, characterized by, that the surface of the counter die 9, 19 is developed as a tier.

11. Punch unit after one of claims 1 to 9, characterized by, that the surface of the counter die 9 is developed as a cylinder.

12. Punch unit according to one of the previous claims, characterized by, that the surface of counter die 9, 19 is in motion with the circumferential speed of the fictive rolling circle 21 perpendicular to the blade 1 at the distance of the rolling circle radius r_{W} from axis of rotation 27 of the blade 1, 13 while turning the circular blade 1 relative too the axis of rotation 27.

13. Punch unit according to claim 12, characterized by, that the number of cutting elements 2 of the circular blade 1 which interfere with the opening 12, 20 of the counter die 9, 19 is optional changeably.

14. Punch unit according to a claims 12 or 13, characterized by, that the cutting edge 22 of the opening 12, 20 of the counter die 9, 19 form a outer shape which basically correspond to the cross section of the holes to be made for the binding comb of the ring binding.

15. Punch unit according to claim 10, characterized by, that the surface of counter die 9, 19 stands still relatively to its axis of rotation 27 while turning the circular blade 1.

16. Punch unit according to one of the previous claims, characterized by, that the cutting elements 2 in each case show at least one cutting edge 8, that rises further above the fictive rolling circle 21 with rolling circle radius r_{W} as another cutting edge 8.

17. Punch unit after one of the previous claims, characterized by, that the punch unit is operable in combination with a single-page thread and/or a paper screening plant and/or a binder.
